(19) United States
(12) Patent Application Publication
(10) Pub. No.: US 2013/0085771 A1
(43) Pub. Date: Apr. 4, 2013

(54) METHOD OF DISPLAYING PATIENT DATA IN A MEDICAL WORKFLOW ENVIRONMENT

(71) Applicant: PatientSafe Solutions, San Diego, CA (US)

(72) Inventors: Reza Ghanbari, San Diego, CA (US); Richard Johnson, Carlsbad, CA (US); Todd Werts, San Marcos, CA (US); Christopher Stokes, Murrieta, CA (US); Robert Collins, Brookfield, NH (US); Susan Pede, Encinitas, CA (US); Sue Ann Benner, Valley Center, CA (US); Kirsten Unks, Solana Beach, CA (US); Paul Seelinger, Redondo Beach, CA (US); Gregory Thomas, Temecula, CA (US)

(73) Assignee: PATIENTSAFE SOLUTIONS, San Diego, CA (US)

(21) Appl. No.: 13/628,495

(22) Filed: Sep. 27, 2012

Related U.S. Application Data
(60) Provisional application No. 61/541,946, filed on Sep. 30, 2011.

(51) Int. Cl. G06Q 50/22

(52) U.S. Cl. 705/2

(57) ABSTRACT

An apparatus, a method and a system for displaying patient data in a medical workflow environment are disclosed. The method includes scanning a patient identifier with a hand-held device, displaying patient data on a display screen of the hand-held device, selecting a medication for administration to the patient from a list of one or more medications displayed on the display screen, scanning a medication identifier with the hand-held device, and confirming administration of the medication on the hand-held device

### CROSS REFERENCE TO RELATED APPLICATIONS

This is a non-provisional application claiming priority from and the benefit of U.S. Provisional Application No. 61/541,946, filed on Sep. 30, 2011, the entire contents of which are hereby incorporated by reference.

### BACKGROUND

1. Field of the Disclosure

The present disclosure relates generally to an apparatus, a method or a system for displaying data in a health care environment. Certain embodiments of the disclosure relate to a system for displaying medical workflows on a wireless handheld (also known as a hand-held) device in a medical environment. 2. Description of the Related Art

Some computing tasks or environments require a high degree of mobility, ease of operation, and low cost implementation due to a large number of users. One example of such tasks is the administration and documentation of care provided to patients in a medical or hospital environment. Computer resources in these environments are limited due to inadequate availability of access points such as input/output (I/O) stations or terminals, among other reasons. Although stationary terminals have a large screen, familiar full-featured keyboard, and mouse input devices, such terminals are inconvenient to use in certain environments due to lack of portability, or availability due to cost and space constraints. Notebook computers with wireless communication capabilities can increase the power of computer terminals while maintaining relatively fast and available computing power. However, they are still somewhat large in size, bulky to transport, have limited battery life, require two hands to operate, and are expensive.

A plurality of small sized wireless computing devices have been developed, such as wireless personal digital assistants (PDAs), for use by caregivers in administration and documentation of medical care. For example, U.S. Pat. No. 4,916,441 to Gombrich describes a handheld terminal that includes a wireless transmitter and a bar code scanner for entering medical data into a computer system. Unfortunately, a nurse must manually type much of the information onto a small keyboard on the device. This is inconvenient and time-consuming in a hospital environment. Certain methods for controlling workflow in a medical environment are also disclosed in U.S. Pat. Nos. 7,607,571, 7,364,067, 7,344,079 to Steusloff, et al., each of which is hereby incorporated by reference it its entirety.

In addition, similar devices may be fragile, bulky or expensive, and require two-handed or tedious tasks for operation. Thus, improved devices and methods are needed to provide caregivers with the benefits of modern technology.

### SUMMARY OF CERTAIN INVENTIVE ASPECTS

In one aspect, a method of displaying patient data in a medical workflow environment is provided. The method includes, for example, receiving a patient identifier into a hand-held device configured to read scan codes and configured to receive input via a touchscreen display, displaying patient data on the touchscreen display of the hand-held device, receiving a medication selection for administration to the patient from a list of one or more medications displayed on the touchscreen display, receiving a medication identifier into the hand-held device, and receiving a confirmation of administration of the medication on the hand-held device.

In some embodiments, the method further includes scanning a caregiver identifier with the hand-held device. In some embodiments, the method further includes displaying an indication of a successful scan of a patient identifier on the touchscreen display of the hand-held device. In some embodiments, the selecting a medication for administration to the patient includes, for example, selecting a medication mode from the touchscreen display of the hand-held device. In some embodiments, the display screen is configured to receive input from a user contacting an interface element on the display screen. In some embodiments, the method further includes a plurality of details regarding the selected medication on the touchscreen display of the hand-held device after selecting a medication for administration. In some embodiments, the method further includes displaying an indication of a successful administration of the selected medication on the touchscreen display of the hand-held device after the confirming administration of the medication. In some embodiments, the method further includes displaying an indication of a successful documentation of the administration of the selected medication by a server on the touchscreen display of the hand-held device. In some embodiments, the hand-held device includes a processor, a memory, and a scanner. In some embodiments, scanning a patient identifier includes scanning at least one of a one dimensional code, a two dimensional code and a radio frequency identification tag. In some embodiments, scanning a medication identifier includes scanning at least one of a one dimensional code, a two dimensional code and a radio frequency identification tag. In some embodiments, reading a patient identifier includes scanning at least one of a one dimensional code, a two dimensional code and a radio frequency identification tag. In some embodiments, the displaying patient data on the touchscreen display of the hand-held device includes a link to access additional patient data, medication data, medication administration data, hospital procedures, doctor orders, or medical workflow information. In some embodiments, receiving a medication selection for administration to the patient from a list of one or more medications displayed on the touchscreen display does not disrupt the treatment transaction. In some embodiments, the treatment transaction includes a timer to indicate a window for completion of the treatment.

In other aspect, a hand-held apparatus for use in a medical workflow environment is provided. The hand-held device may include, for example, a processor, a memory electrically connected to the processor, a scanner electrically connected to the processor and configured to read scan codes, a touchscreen display electrically connected to the processor and configured to display user interface elements, a first module including instructions for displaying patient data about a patient, a second module including instructions for receiving a selection of a medication for administration to the patient from a list of one or more medications displayed on the touchscreen display, and a third module including instructions for displaying confirmation of an administration of the medication for administration on the touchscreen display.

In another aspect, a system for displaying patient data in a medical workflow environment is provided. The system may include, for example, a hand-held device configured to read scan codes and read a patient identifier, the hand-held device including a processor, a memory, and a touchscreen display and a server in wireless communication with the hand-held device, the server configured to receive the patient identifier from the hand-held device, to transmit patient data for display on the touchscreen display, and to receive a medication identifier from the hand-held device.

In some embodiments, the hand-held device is further configured to display patient data on the touchscreen display. In some embodiments, the hand-held device is further configured to receive a selection of a medication for administration to a patient from a list of one or more medications displayed on the touchscreen display. In some embodiments, the hand-held device is further configured to display a plurality of details regarding the selected medication on the display screen of the hand-held device after selecting a medication for administration. In some embodiments, the hand-held device is further configured to display a confirmation of administration of the medication on the touchscreen display. In some embodiments, the hand-held device is further configured to scan a caregiver identifier. In some embodiments, the hand-held device is further configured to display an indication of a successful scan of a patient identifier on the touchscreen display. In some embodiments, the hand-held device is further configured to display an indication of a successful documentation of the administration of the selected medication by a server on the touchscreen display. In some embodiments, reading a patient identifier includes scanning at least one of a one dimensional code, a two dimensional code and a radio frequency identification tag. In some embodiments, the displaying patient data on the touchscreen display of the hand-held device includes a link to access additional patient data, medication data, medication administration data, hospital procedures, doctor orders, or medical workflow information. In some embodiments, receiving a medication selection for administration to the patient from a list of one or more medications displayed on the touchscreen display does not disrupt the treatment transaction. In some embodiments, the treatment transaction includes a timer to indicate a window for completion of the treatment.

In some embodiments, a particular screen, mode, context, or color can be used to indicate availability of a caregiver. In some embodiments, a screen color indicates whether a caregiver may accept a notification, a message, an alert, or an order or whether the caregiver must complete a particular task before receiving such. In some embodiments, a caregiver is required to complete documentation of treatment before receiving a message, an alert, or an order or before performing any new task using a handheld device of the present disclosure.

### BRIEF DESCRIPTION OF THE DRAWINGS

Features of the present disclosure will become more fully apparent from the following description and appended claims, taken in conjunction with the accompanying drawings. In the drawings, like reference numbers indicate like elements. It will be understood these drawings depict only certain embodiments in accordance with the disclosure and, therefore, are not to be considered limiting of its scope; the disclosure will be described with additional specificity and detail through use of the accompanying drawings. An apparatus, system or method according to some of the described embodiments can have several aspects, no single one of which necessarily is solely responsible for the desirable attributes of the apparatus, system or method. After considering this discussion, and particularly after reading the section entitled “Detailed Description of Certain Inventive Embodiments” one will understand how illustrated features serve to explain certain principles of the present disclosure.

FIG. 1 is a block diagram of one embodiment of a medical management system.

FIG. 2 is a block diagram of one embodiment of a server used in the medical management system of FIG. 1.

FIG. 3 is a block diagram of one embodiment of a plurality of modules configured to communicate with the microcontroller of a wireless terminal.

FIG. 4A is a flowchart illustrating one embodiment of a method of operating a wireless terminal during a communication session with the server.

FIG. 4B is a flowchart illustrating one embodiment of a method of operating the server during a communication session with a wireless terminal.

FIG. 5 is a flowchart illustrating one embodiment of a method of operating the server.

FIG. 6 is an exemplary diagram of a user interface topology.

FIGS. 7A-7D are exemplary screens of a user interface on a touchscreen wireless terminal configured to participate in a medical management system.

FIG. 8 illustrates a block diagram of one embodiment of a method of displaying patient data in a medial workflow environment.

FIG. 9 is a screenshot of a handheld device in a “green” mode in which a caregiver has committed to a medical treatment or medical administration for a patient.

### DETAILED DESCRIPTION OF CERTAIN INVENTIVE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present disclosure. The drawings and description are to be regarded as illustrative in nature and not restrictive. However, it should be understood that the disclosure is not limited to a specific embodiment but includes all changes and equivalent arrangements and substitutions included in the spirit and scope of the disclosure. Descriptions of unnecessary parts or elements may be omitted for clarity and conciseness, and as mentioned above, like reference numerals refer to like elements throughout.

One embodiment is a method of displaying patient data in a medical workflow environment. The method begins with a caregiver scanning a patient identifier into a hand-held device that is configured to read scan codes and configured to receive input via a touchscreen display. Scanning the patient initiates a treatment transaction. After the caregiver scans the patient, the hand-held device displays patient data on the touchscreen display, including, for example, medication orders for that patient. The caregiver then selects a medication for administration to the patient from a list of one or more medications displayed on the touchscreen display. After the caregiver selects a medication, the caregiver scans a medication identifier into the hand-held device to confirm the correct medication is being administered. Finally, the caregiver receives a confirmation of administration of the medication on the hand-held device. In an additional embodiment, the caregiver may scan his or her own identifier with the hand-held device to conclude the treatment transaction. In some embodiments, the hand-held device may display an indication of a successful scan of a patient identifier on the touchscreen display. In some embodiments, the hand-held device may display a plurality of details regarding the selected medication on the touchscreen display after being selected. In some embodiments, the display of the plurality of details regarding the selected medication or display of additional information regarding the patient will not disrupt the treatment transaction. In some embodiments, the treatment transaction includes a timer for completion of the treatment. In some embodiments, the hand-held device may display an indication of a successful documentation of the administration of the selected medication by a server on the touchscreen display after confirming the administration of a medication to the patient.

Embodiments of the present disclosure relate to an apparatus for displaying workflows in a medical environment. One embodiment relates to a method and a system for displaying medical workflows on a wireless handheld device in a medical environment. Within a hospital, patients are given a wide variety of treatments and medicines. The use of handheld devices as described herein may increase the proficiency of the administration of treatments and medicines. In particular, the use of handheld devices may improve practices meant to protect patient rights. For example, with respect to administering a medication to a patient, that patient's rights may include: (1) treating the right patient; (2) with the right medication; (3) the medication given at the right dosage; (4) the medication given by the right route (e.g. IV); (5) the medication given at the right time; (6) the medication given for the right reason(s); and (7) the details of the medicine administration being documented correctly. Thus, one embodiment relates to a handheld device that receives data regarding steps for treatment of a patient (i.e. a treatment transaction) that are displayed in such a way as to increase both the correctness of the treatment and also the recordation of treatment details in the patient's medical record. This better protects that patient's rights with respect to his or her treatment. Additionally, one embodiment of a handheld device may provide quick access to a patient's existing patient data, such as his or her electronic health record, to further increase the efficacy of treatment.

Embodiments may relate to a system and method employing a wireless handheld terminal, also known as a wireless device, for management of medical care in an environment such as a hospital. The wireless terminal may have at least one code reader, or scanner, used to read codes or symbols corresponding to, for example, patient identification, item identification, documentation characters and phrases, commands, and instructions. In some embodiments, the scanner may be a function of an image capture device, such as a camera, configured with appropriate software for determining a scanned code based on a received image. The codes or symbols may be machine readable codes or symbols, including one and two dimensional optically readable codes or symbols such as bar codes, but can also include radio frequency identification (RFID) devices or tags. The codes or symbols can be applied to objects, cards, placards or other surfaces and objects throughout the hospital environment.

The codes or symbols used and maintained by the medical management system may be in a “closed” symbology, such that only one code corresponds to a particular instruction or piece of information. This ensures that the system does not receive duplicate codes or symbols which correspond to different instructions or information. In certain embodiments, the codes or symbols are implemented as a 2-D matrix, or DOT as described in International Publication No. WO 02/07065, which is hereby incorporated by reference in its entirety. In one embodiment, the physical DOT is 7 mm in diameter, and includes 321 white or dark hexagons. In another embodiment, the physical DOT is approximately 5 mm in diameter, but less than 7 mm in diameter. In one embodiment, a computer server can be configured to generate a 64-bit number, encrypt it, and algorithmically produce a 2-D DOT which uniquely represents encoded data. Where the system is implemented using the DOT symbology, the system can have additional capabilities such as the methods and systems described in International Publication No. 02/21794 A2, which is hereby incorporated by reference in its entirety. As used herein, a “dot scanner” is configured to read the DOT symbology. The system can also function using other one-dimensional or two-dimensional symbols such as AZTEC® codes and two-dimensional barcodes along with the DOT as described in International Publication No. WO 02/07065, which is hereby incorporated by reference in its entirety.

The 2-D DOT or other one-dimensional or two-dimensional symbols advantageously permit high density placement of DOTs or other one-dimensional or two-dimensional symbols as explained in Publication No. 02/21794 A2. The DOTs or other one-dimensional or two-dimensional symbols can be placed adjacent to one another in the same horizontal row or vertical column without the data from one DOT or other one-dimensional or two-dimensional symbols interfering with the ability of a terminal to read an adjacent DOT. Thus, the DOTs or other one-dimensional or two-dimensional symbols can be arranged as an array of DOTs or other one-dimensional or two-dimensional symbols. In one embodiment, a center to center distance between adjacent DOTs or other one-dimensional or two-dimensional symbols is approximately 20 mm and is less than 25 mm. In other embodiments, the center to center distance between adjacent DOTs or other one-dimensional or two-dimensional symbols is less than about 10 mm, 15 mm, 20 mm, 30 mm, 35 mm, 40 mm, 45 mm, 50 mm, 55 mm, 60 mm, 65 mm, 70 mm, 75 mm, 80 mm, 90 mm, or 100 mm.

Due to the vast number of data combinations made possible by the DOT or other one-dimensional or two-dimensional symbols, a vast number of uniquely identifiable information and commands may be stored by the medical management system. Thereby, the possibility of confusion with commonly used bar codes is eliminated. The system may, however, be implemented with both DOTs or other one-dimensional or two-dimensional symbols and bar code technology, where the terminal may include both a bar code scanner and a DOT or other one-dimensional or two-dimensional symbol scanner. In some embodiments a single scanner may scan both bar codes and DOT or other one-dimensional or two-dimensional symbol. For example, an image sensor on a wireless device may be configured to scan both a bar code and a DOT or other one or two-dimensional symbol using image capture techniques as are known in the art.

Embodiments of a wireless terminal may also include a touchscreen type interface, such as a touch-enabled graphical user interface, for interacting with program modules. Touchscreen sensors may be integral with a display and may include technology such as capacitive touch-sensors, resistive touch-sensors and others as are known in the art. The touchscreen interface may allow a caregiver to provide data or an instruction to a medical management system, or to receive the same from the system, via, for example, a connected server. Additionally, a wireless terminal may provide data or instructions via a direct wired or wireless link to a peripheral device, such as an intravenous delivery device (for example, an IV pump). By interacting with the touchscreen interface, a user, such as a nurse, can send and receive messages, page other caregivers, print, and interact with program modules stored on the wireless terminal. For example, in one embodiment, a nurse may need to administer a drug to a patient. In this embodiment, the nurse may scan a patient identifier, such as a patient ID bracelet, which includes a scan code sequence identifying the patient. The nurse may then view information on the wireless terminal regarding one or more treatments for the patient, such as the administration of an antibiotic drug. The nurse may then scan a drug for administration so that the system may verify that it is the correct drug for the patient. Subsequently, the nurse may administer the drug and record details of the administration (for example, an amount of drug administered and site of administration) on the wireless terminal using the touchscreen interface. The details of the administration may then be sent to the medical management system via wired or wireless data link to be recorded in the patient's electronic health record as well as in other systems as necessary (for example, the pharmacy system).

Embodiments of wireless terminal may also be adapted with audio indicators such as a beep to indicate a warning condition or a message awaiting acknowledgement. A user may acknowledge or respond to audio indicators by pressing a button on the terminal or by pressing a soft-button on the touchscreen interface. As one example, a nurse might scan in a code from a packet of Digoxin, which is a medicine to treat heart problems that should be administered only after an apical pulse measurement has been taken by the nurse. Once the nurse scans the code from the Digoxin packet, the terminal may determine that an apical pulse measurement is required before administration, and may output an audio indicator such as a beep along with displaying a warning on the screen. The nurse may then take the apical pulse and enter it into the wireless terminal using the touchscreen interface. Once the pulse measurement is entered, the wireless terminal may transmit the pulse data to the server to be recorded with other details of the treatment.

The wireless terminal may establish communication with a medical management system server that maintains one or more databases. One database may include codes or symbols and corresponding information or commands, which the medical management system uses to process codes or symbols received from a wireless terminal. Another database may include patient identification information so that when a caregiver scans a patient the system may retrieve relevant data regarding that patient. The server is may be in communication with additional devices via a network, such as a local area network (LAN), where the additional devices perform a variety of functions, such as messaging, printing, or record keeping. The server may also be configured to communicate with the wireless terminal to provide requested information or information in response to scanning of particular codes or symbols, such as codes or symbols corresponding to a particular medication. In some embodiments, the terminal may also bypass a server and communicate directly with a peripheral device, such as an intravenous delivery pump, either via wired or wireless data link.

In one aspect of the disclosure, the wireless terminal may include processing capabilities such that it can process codes or symbols locally without communicating with a server. The wireless terminal may be configured to store data in advance, such as a database of codes and symbols, so that the caregiver can make rounds without the need to communicate with the server constantly. The wireless terminal may be configured to only communicate with a server when it is necessary, for example, on-demand, so as to maximize network availability and to save battery power.

As used herein, “instructions” refer to computer-implemented steps for processing information in the system. Instructions can be implemented in software, firmware or hardware and include any type of programmed step undertaken by components of the system. As used herein, the term “manual instructions” are those steps that may be implemented by humans interacting with the system.

As used herein, a “code which corresponds to instructions” or a “code corresponding to an instruction” means a code that refers to, or is converted into, one or more instructions to be carried out in the system. For example, a code “ABC123” might point to an instruction that results in a doctor being paged to a particular room. As another example, a code might trigger an intravenous delivery system to access specific medication information and settings for a specific patient and specific medication order corresponding to that patient. The specific settings can be accessed from remote storage, such as a networked server, from information resident in the handheld terminal or from information resident in the device, such as within the intravenous delivery system. Codes or symbols and their corresponding instructions can be stored in a database or lookup table so that scanning in a code causes the terminal to lookup the code in the database and retrieve its corresponding instruction, or set of instructions. As described, codes or symbols may be converted into 1D or 2D symbols so that they can be conveniently scanned into the system.

One example of a Local Area Network may be a corporate computing network, including access to the Internet, to which computers and computing devices including the system are connected. In one embodiment, the LAN conforms to the Transmission Control Protocol/Internet Protocol (TCP/IP) industry standard. In alternative embodiments, the LAN may conform to other network standards, including, but not limited to, the International Standards Organization's Open Systems Interconnection, IBM's SNA, Novell's Netware, and Banyan VINES.

As used herein, a “microprocessor” may be any conventional general purpose single- or multi-chip microprocessor such as a Pentium® processor, a 8051 processor, a MIPS® processor, a Power PC® processor, an ALPHA® processor, an ARM processor, a RISC processor or any one of a number of microcontrollers or other devices that process instructions that may be measured in number of instructions per second, for example, millions of instructions per second (MIPS). In addition, the microprocessor may be any conventional special purpose microprocessor such as a digital signal processor or a graphics processor. The microprocessor typically has conventional address lines, conventional data lines, and one or more conventional control lines.

As used herein, the term “module” refers to the various modules in the system as discussed in detail below. As can be appreciated by one of ordinary skill in the art, each of the modules may include various sub-routines, procedures, definitional statements and macros. Each of the modules are typically separately compiled and linked into a single executable program; however, each module may be compiled together as a single executable program. Therefore, the description of each of the modules is used for convenience to describe the functionality of embodiments of the system and not to limit the structural implementation of the modules in source code. Thus, functions within a module may be arbitrarily redistributed to another module, or functions implemented in multiple modules may be combined together in a single module, or made available in, for example, a shareable dynamic link library.

The system may include any type of two or more electronically connected computers including, for instance, the following networks: Internet, Intranet, Local Area Networks (LAN), Wide Area Networks (WAN) or direct connections such as peer-to-peer connections. In addition, the connectivity to the network may be, for example, remote modem, Ethernet (IEEE 802.3), Token Ring (IEEE 802.5), Fiber Distributed Datalink Interface (FDDI) or Asynchronous Transfer Mode (ATM). Note that computing devices may be desktop, server, portable, handheld, set-top, or any other desired type of configuration. As used herein, an Internet includes network variations such as public internet, a private internet, a secure internet, a private network, a public network, a value-added network, an intranet, and the like.

As used herein, the term “programming language” refers to any programming language including, but not limited to, C, C++, C#, BASIC, Pascal, Java, FORTRAN, and Assembly Language. C, C++, C#, BASIC, Pascal, Java, and FORTRAN are industry standard programming languages for which many commercial compilers can be used to create executable code.

### System Overview

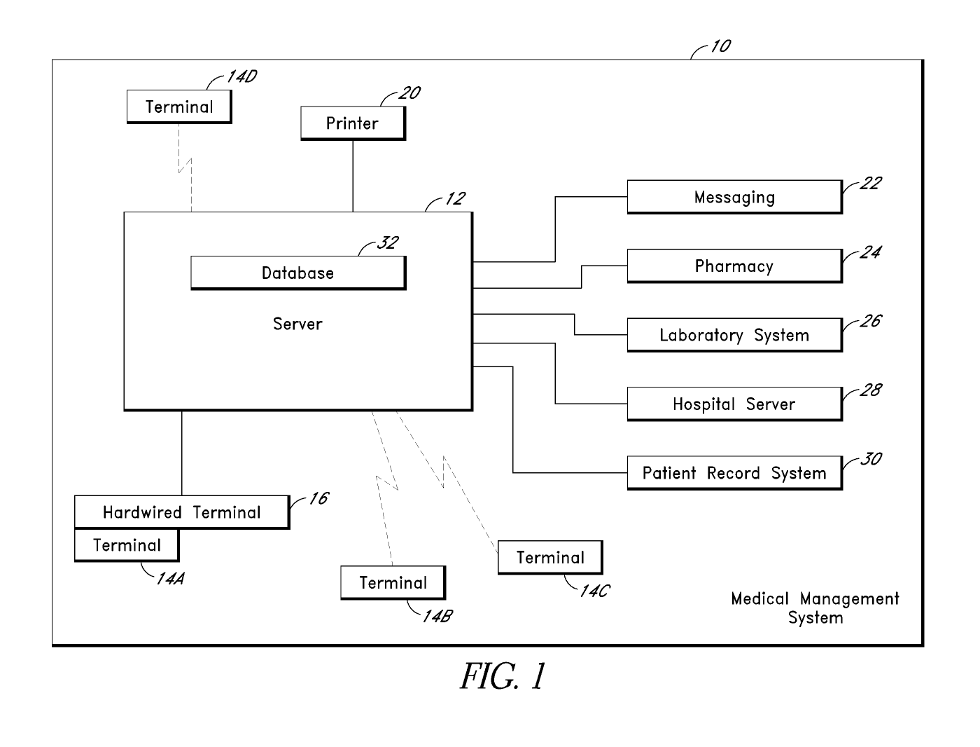

FIG. 1 is a block diagram of one embodiment of a medical management system 10 implemented in a hospital environment. The system 10 includes a computer or server 12, and a plurality of battery powered wireless terminals 14A-D, wherein the wireless terminals 14 and server 12 may communicate according to IEEE 802.11 wireless LAN specifications. The system can also use other wireless communications specifications known in the technology, including, but not limited to, infrared data association (IrDA), radio frequency identification (RFID) or Bluetooth. The system may also include a hardwired terminal 16 coupled to the server 12 via a network or direct connection, wherein the hardwired terminal 16 can be used as a control point or data viewing and manipulation portal for the system such that only authorized users can activate a terminal 14A, and as a hardwired communication link between a terminal 14 and the server 12.

The wireless terminals 14 and server 12 are configured to communicate both constantly and periodically. By communicating periodically, battery power at the wireless terminals 14 can be conserved and situations where the terminal 14 is out of communication range with the server 12 do not create power consuming loop processes wherein the terminal 14 continually attempts communication with the server 12. The server 12 and wireless terminals 14, however, can communicate as needed so long as they are in communication range of each other, and are not limited to communication during the designated communication sessions.

The server 12 is also coupled to a plurality of peripheral devices and systems, such as a printer 20, a messaging system 22, a pharmacy system 24, a laboratory system 26, a hospital server 28, a financial system 29 and a patient record system 30, via a network connection. Commands, instructions, queries or other messages received from the wireless terminals 14 are communicated by the server 12 to the various devices and systems for performance of requested tasks, and information from the various peripheral devices and systems are communicated to the wireless terminals 14 by the server 12. For example, the pharmacy system 24 can send updated medication information for patients or send notifications to the server 12 when a patient's medication is ready. A terminal 14 can also query the pharmacy system 24 for information via the server 12. Similarly, a terminal 14 can send laboratory test requests to the laboratory system 26, or receive test results from the laboratory system 26 via the server 12. Additionally, the system 10 can send billing and charge data to the financial system 29 based upon the information gathered by the system 10 during its use.

Where the hospital server 28 maintains, for example, patient registration information, the hospital server 28 can send updated information to the server 12, and the wireless terminals 14 can update the hospital server 28, for example, when a patient has been discharged.

In one embodiment, the patient record system 30 is an Electronic Medical Record (EMR) system, also known as an Electronic Health Record (EHR) system, and is updated with information from the wireless terminals 14 so as to maintain an electronic record of each patient's care, including treatments, interventions, recorded vitals, medicine administrations and others.

Thus, the wireless terminals 14 have capabilities similar to computer terminals which are connected to the peripheral devices and systems through a conventional network. Peripheral devices may include, for example, an intravenous delivery pump.

The server 12 may include a database 32 for storing, among other things, a plurality of scan codes or symbols and each codes or symbols' corresponding data or instruction in order to perform a plurality of electronic tasks. Scan codes or symbols can also be stored on the handheld terminal and/or on a device such as an intravenous pump. The data includes, for example, information corresponding to a patient, medication, objects, and note taking entries, and the instructions can include tasks such as “print a patient report”, “order laboratory tests”, and “request assistance”. The database 32 can be modified and maintained using the terminal 16 or additional computer terminals in communication with the server 12. In certain embodiments, the system includes both a local server and a remote server, including local and remote databases. In such embodiments, the local databases may provide pointers to locate the appropriate remote server, or the local and remote servers may operate or interface together in a different manner. In addition, where a plurality of servers and databases are used in a single hospital, for example, a master computer or server can be used to maintain and update the databases. Other embodiments of the server 12 may include additional databases such as databases of patient data, caregiver data, hospital data, medicine data, treatment data, and other types of data as are required.

### Server

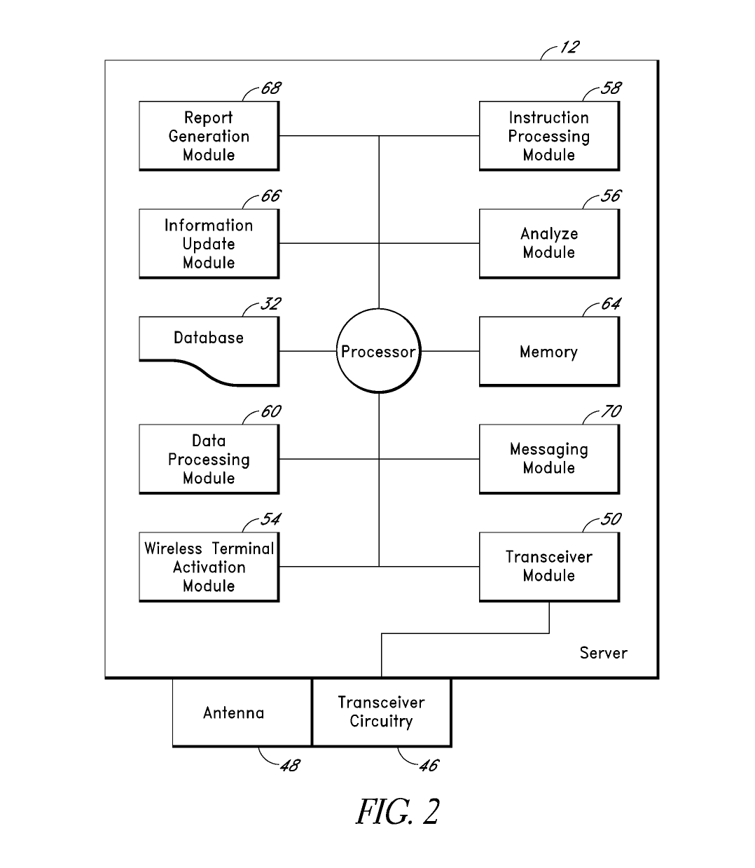

FIG. 2 is a block diagram of one embodiment of the server 12, wherein the server 12 is in data communication with transmit and receive, or transceiver circuitry 46 including an antenna 48 for wireless communication with the plurality of wireless terminals 14. The server 12 may include additional transmit and receive circuitry for processing of data and instructions where the server 12 is linked to a wireless access point including a transceiver and antenna. As described above, the server 12 can also communicate with the wireless terminals 14 via a hardwired connection at the hardwired terminal 16.

The server 12 includes a transceiver module 50 configured to receive and facilitate transmission of data via the transceiver circuitry 46. In some embodiments, the server 12 may include a network interface component and the function of broadcasting and receiving wireless data packets may be accomplished by an external transceiver, such as a wireless router or wireless access point.

The server 12 further includes an activation module 54 configured to initiate each terminal 14 at the beginning of each use. In one embodiment, a user may request activation of a terminal 14 by scanning a code (or codes or symbols) corresponding to user information, such as a username and password, or by entering the same via a wireless terminal's touchscreen interface. In one embodiment, the user scans an identification code on their name badge, and thereafter enters a password into the touchscreen interface. In response to an activation request, the activation module 54 first verifies whether the user is authorized to use the terminal 14 by correlating the user information with information stored in a database, such as the database 32 of the system 10. Once a caregiver has been verified by the system 10, the activation module 54 may send a list of tasks to be performed and information to be used by the caregiver. For example, where Nurse A requests activation of a terminal 14, the activation module 54 may send information corresponding to Patients A, B, C, and D, who are assigned to Nurse A, to the terminal 14 along with any additional tasks to be performed by Nurse A for those patients or in general.

As shown in FIG. 2, the server 12 also includes an analyze module 56 in data communication with the transceiver module 50 and configured to analyze incoming data or instructions from the wireless terminals 14 via the transceiver circuitry 46. The analyze module 56 is in data communication with additional processing and task performance modules at the server 12, and communicates the incoming data or instruction to the appropriate module according to its analysis. As will be appreciated by those skilled in the art, the server may include a separate analyze module or plurality of modules for analysis of data or instructions from the peripheral devices and systems and for analysis of data and instructions from the wireless terminals 14.

The server 12 further includes an instruction processing module 58 for processing an instruction, and a data processing module 60 for processing data, wherein analysis by the analyze module 56 determines whether a communication from a networked terminal 14 may include data or an instruction, and sends the communication contents to the appropriate module for processing. The server 12 also includes a processor 62 and a memory 64, used by instruction processing and data processing modules 58, 60 during operation. The memory 64 can also be configured to store the database 32 data. It should be realized that additional memory types, such as a flash memory, ROM, RAM, EEPROM, and others may also be used to store data within the server 12.

The memory 64 is also configured to store information received from peripheral systems, which may then be accessed by the wireless terminals 14. For example, where a server 12 is assigned to each nursing station in a hospital, the memory 64 stores information corresponding both to the patients assigned to the nursing station and to the tasks to be performed by the caregivers assigned to the patients. More specifically, the medications, time of administration, and any additional information regarding the care of a patient may be stored in memory 64 for use by the caregiver assigned to patient. In other embodiments, the treatment data may be synchronized to the wireless terminals 14 so that the terminals 14 need not constantly access the server 12.

The additional processing and task performance modules at the server 12 may include an information update module 66, configured to update information stored in memory 64 with information from the plurality of peripheral devices and systems. For example, the information update module 66 receives medication orders from the pharmacy system, updates the memory 64 with the pharmacy orders, and sends updated medication orders to the appropriate wireless terminals 14.

As shown in FIG. 2, the server 12 further includes a report generation module 68 configured to generate reports for a particular patient or for all patients assigned to the user of the terminal 14 in response to an appropriate instruction from a terminal 14. The report generation module 68 receives a report generation instruction from the instruction processing module 58, and uses the processor 62 and memory 64 to obtain the information to be included in the report. Once the information has been gathered, the report generation module 68 may send the report to a printer.

In one embodiment, the server 12 also includes a messaging module 70 configured to receive, generate, and send messages to the wireless terminals 14 and peripheral systems. The module 70 receives messages from the messaging system 22 (FIG. 1) to be sent to the wireless terminals 14. The messaging system 22 can include a computer terminal, or plurality of terminals, where a user can enter a text message to be sent to a particular wireless terminal 14. For example, a text message including notification of an urgent telephone call can be entered at the hardwired terminal 16 for Nurse A. The messaging system 22 communicates the message and corresponding terminal user identification (“Nurse A”, for example) to the server 12. The server 12 routes the message and user identification to the messaging module 70, which looks up the user identification (Nurse A) in the database 32 or memory 64 to determine which terminal 14 should receive the message. The messaging module 70 then formats the message for the destination terminal 14 and sends the message via the transceiver module 50 and transceiver circuitry 46 to the terminal controlled by Nurse A.

In one embodiment, the report generation module 68 is configured to generate a message to notify the user of the terminal 14 when a report has been printed. The generated message is then communicated to the messaging module 70, which is configured to format the message and add information for communication to the appropriate terminal 14.

In one embodiment, the patient record system 30 maintains an electronic record for each patient with respect to medication administration, including, but not limited to, type of medication, quantity of medication administered, how administered, time of administration, observations and other data that may be of value to caregivers and/or the insurers of patients. This electronic record may be referred to as an Electronic Health Record (EHR) or Electronic Medical Record (EMR) as mentioned above. This information may then be stored at the server 12 or terminal 14, such that the server 12 may generate an alert or notification message if a terminal fails to timely send data indicating administration of a scheduled medication. Alternately, the terminal may generate an alert or notification message if expected medication administration is not received by the stored time of administration, or within a predefined time period prior to the specified time of administration. The server 12 may also send EHR data to the terminal 14 if a request is made by a user. In some embodiments, the EHR data may be stored only on the server 12 and only sent to the terminal 14 on an as-needed basis to comply with certain health information regulations, such as the Health Insurance Portability and Accountability Act (HIPAA) and others. In some embodiments, the EHR data may be erased off of the terminal after a predefined period of time has passed.

For example, a patient may be scheduled for administration of a particular medication at a predetermined time. The terminal 14 tracks an elapsed time after a predetermined medication administration time and may generate an alert or notification message if no indication of medication administration has been received within a predetermined alert time. The predetermined alert time may be, for example, 30 minutes or one hour after a scheduled administration time. Thus, the terminal 14 may be configured to monitor for an event where the time elapsed since the scheduled time exceeds some predetermined latency time. The terminal 14 may transmit the message to the server 12 for entry into the patient's EHR. The terminal 14 may continue to periodically alert the user of the terminal 14 until the user acknowledges the alerts or the expected information is entered at the terminal 14.

Alternatively, the server 12 may send a message to a terminal 14 in response to some predetermined patient event. For example, a patient may have had one or more lab tests ordered to evaluate a condition. The server 12 may send a message to a terminal 14 in response to events such as availability of lab results for a particular patient, changes in patient medication, changes in patient health which may be monitored manually or through the use of telemetry, or some other predetermined event, such as a critical abnormal lab result.

In one embodiment, the server 12 maintains statistics on usage related to each individual terminal 14, the user, time information, and the type of code (barcode or DOT, for example) read by the user during each code read or scan event. In addition, information regarding, for example, mistakes in medication administration or user operation of the terminal, misreads of the code scanners, or other operational activity outside of an ideal work flow is tracked by the server. Such tracking or compilation of statistics provides for future performance improvement and optimization of the system.

### Terminal

A terminal 14 may be designed to fit comfortably in one hand of a user, and the features of the terminal 14 are positioned so that the user may operate the terminal with one hand. In one embodiment, the terminal includes a touchscreen display, which may be a backlit liquid crystal display (LCD) with an integral capacitive touch sensor. The display may be used to display patient data, warnings, prompts, messages, etc., to a user as well as to receive data entry from the user. Of course, the present disclosure is not limited to any particular type of display. For example, the display may include an Organic Light Emitting Diode (OLED) type display with a multi-touch capable touchscreen sensor.

The terminal 14 may also include indicators, such as an LED indicator 74 which, for example, may illuminate briefly to notify a user of a pending message or when a code has been properly scanned. The terminal 14 may also include additional indicators, such as a power source indicator and a wireless connectivity indicator (not shown). In some embodiments, such indicators may be incorporated as part of the display, or may be displayed on the display screen using appropriate software.

The terminal 14 may also include software that creates a variety of “soft” interface elements, such as buttons, tabs, icons, fields, scroll wheels and other that are known in the art. For example, a terminal may include a “soft” barcode scan button to activate a code scanner. The soft interface elements may provide information to a user and provide a user with a means of navigating different menus, pages, tabs or other data organization structures. Some interface elements may only be rendered when they are necessary to a current action. For example, an “OK” button may be rendered when after a message is received on the terminal. Additionally, terminal 14 may also include “hard” interface buttons, switches, toggles, etc., which interface with the user interface just like on-screen interface elements. For example, a terminal may include a physical button that causes a scan operation to be initiated.

The terminal 14 may also include a microcontroller such as a processor. The processor may be used to run an operating system and software modules within that operating system. The processor may be used to analyze data and to format data according to software module needs.

The terminal 14 may also include a memory. The memory may be random access memory (RAM) or flash memory or other types of memory as are known in the art. The memory may be configured to store program and application data, and may be capable of supporting a real-time operating system and application data. The memory may be configured for permanent storage of boot firmware, operating system, driver, protocol stack, and application programming. The memory may also be configured for low power operation.

The terminal 14 may also include a plurality of interfaces for communication with a plurality of peripheral devices. In one embodiment, the terminal 14 further includes an external bus interface, such as a Universal Serial Bus (USB) port. In other embodiments, the terminal 14 may use a wireless communication interface, such as a Bluetooth, to communicate with peripheral devices and other terminals.

The terminal 14 may also include a real time clock, such as the Real Time Clock chip DS2415 from Maxim Semiconductor (Dallas), to provide the processor with real time information.

The terminal 14 may also include a communication transceiver that is configured to communicate with the server 12 using wireless communication specifications such as RF, Bluetooth, IrDA or a WLAN specification, such as IEEE 820.11.

The terminal 14 may also include a display controller that is configured to interface with the display. The display controller can be implemented, for example, as a separate chip, or as part of a combined processor die. The display controller may be configured to display predefined symbols, such as a battery power indicator, battery charge status indicator, wireless communication status, and wireless communication signal strength on the display screen as well as other program specific graphics.

The terminal 14 may also include a user input controller, such as a touchscreen input controller, to monitor and receive input from one or more input devices. The user input controller may interface with the processor so that input data may be provided to the processor as actionable data.

The terminal 14 may also include one or more audio indicators, such as a piezo speaker and driver, coupled either directly to the processor or through a bus. The audio indicator may provide acknowledgement to a user of, for example, a successful code decoding of a barcode or DOT image, and may also notify a user of a waiting message, alarm, or warning. The audio indicator may also produce different audio signals to indicate different conditions to the user, such as a first audio signal to indicate a successful code reading and decoding, and a second, different audio signal to indicate an unsuccessful code reading and/or decoding. An enhanced speaker may also provide feedback in the form of speech or other audio signals.

The terminal 14 may also include a barcode reader, which may be implemented with a modular barcode scan engine such as a miniaturized, high performance 650 nm laser-based, single-line decoded scan engine from Symbol Technologies (Model No. SE-923). The scan engine may be modular and self-contained, and may include a microcontroller configured to decode a barcode into a format compatible with and readable by the processor. In certain embodiments, the barcode reader is implemented with a scan engine which is not configured to decode a barcode, and the terminal 14 further includes additional decoding or conversion circuitry configured to convert barcode data into an acceptable format for processing. In other embodiments, the barcode reader may be implemented with an image capture device integral to the terminal, such as a camera, and appropriate software.

The terminal 14 may include a battery monitor and safety circuit coupled to a battery power interface. The battery power interface may be configured to draw power from a rechargeable battery, such as a Li-Ion polymer battery. In one embodiment, the battery and the battery monitor and safety circuit are a single unit. Where a rechargeable battery is used, the terminal 14 may further include a battery charger interface configured to interface the battery monitor and safety circuit with an external battery charger through metallic charger contacts, for example. The battery monitor and safety circuit may be configured to monitor the power level in the battery and conditions during charging. In one embodiment, the terminal 14 includes one or more voltage converters such as the Micropower Synchronous Buck-Boost DC/DC converter by Linear Technology (LT3440EMS).

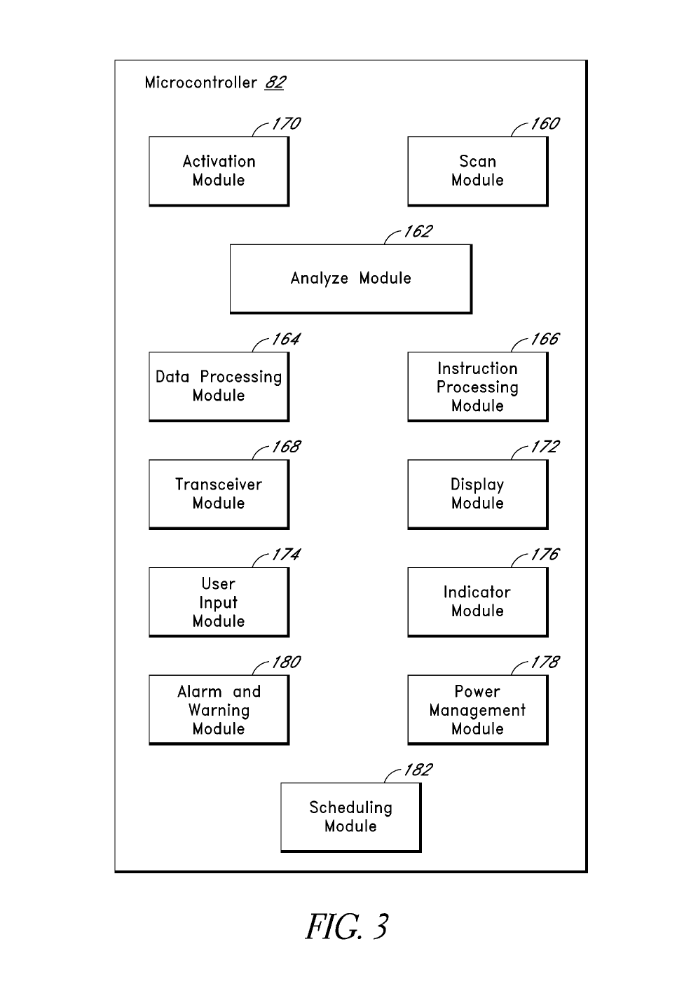

FIG. 3 is a block diagram illustrating one embodiment of a plurality of modules for implementation at the microcontroller 82. As will be appreciated by one skilled in the art, the following described modules may be implemented in conjunction with processors and storage devices in addition to or in place of the microcontroller 82. In some embodiments, microcontroller 82 may be a component of the terminal 14 illustrated in FIG. 1. As illustrated in FIG. 3, the microcontroller 82 includes a scan module 160 configured to process the codes or symbols read by the code scanners and an analyze module 162, configured to analyze the processed scan codes or symbols. The analyze module 162 is configured to determine, for example, whether a scan code corresponds to data or an instruction. If the analyze module 162 determines that a scan code corresponds to data, the data scan code is processed at a data processing module 164. If the analyze module 162 determines that a scan code corresponds to an instruction, then the instruction scan code is processed at an instruction processing module 166.

The data or instructions corresponding to the scan codes or symbols may be used or performed locally at the terminal 14, or transmitted to the server 12 via the communication transceiver 102. The microcontroller 82 may include a transceiver module 168, which is configured to format data or an instruction for communication to the server according to the communication specifications of the communication transceiver 102.

The microcontroller 82 also includes an activation module 170 configured to operate in conjunction with the activation module 54 at the server 12 when a user requests activation of a terminal 14. Following user authorization by the server 12, the activation module 170 is configured to process information sent by the activation module 54 at the server 12 and store the information in memory.

Referring to the example previously discussed, Nurse A requests activation of the terminal 14 by scanning a code on her identification badge. Upon authorization of Nurse A to use the terminal 14, which may also include input of a password, the activation module 170 coordinates receipt of information corresponding to Patients A, B, C, and D, who are assigned to Nurse A, along with any additional tasks to be performed by Nurse A for those patients or in general. The activation module 170, or another data storage mechanism then stores the received information in memory. The activation module 170 may also be configured to store the authorized user's identification code in memory, such that data and instructions sent to the server 12 can be tagged with the user's identification for future use, for example, in record keeping. In one embodiment, the terminal 14 communicates with the server 12 using a hardwired connection during an activation procedure.

The microcontroller 82 further includes a display module 172 configured to facilitate display of messages, text, and indicators on the display 72 via the display controller.

The microcontroller 82 also includes a user input module 174, configured to monitor and process user input received by, for example, a touchscreen display. The user input module 174 responds to the received input accordingly, for example, depending on the message being displayed on the display.

The microcontroller 82 may further include an indicator module 176 configured to control illumination of, for example, an LED configured for illumination. For example, an LED may be illuminated to notify a user that the terminal 14 is awaiting acknowledgment of a message or has displayed a warning at the display. Where the terminal 14 includes an auditory indicator, the indicator module 176 may be further configured to facilitate activation of the auditory indicator, such as a beep or buzz, as a warning or to indicate that, for example, a code has been properly or improperly read by the scanners. The terminal 14 can include a plurality of auditory indicators, which can be downloaded, for example, from the server 12 via a hardwired or wireless connection.

The microcontroller 82 also includes a power management module 178 configured to monitor remaining battery power via the battery monitor and safety circuit, and to schedule low power or no power operation of terminal components to conserve power. The power management module 178 may also be configured to facilitate display of the amount of available power or status of the battery via an indicator as discussed above. The power management module 178 may be further configured to facilitate communication of this information to the server 12. In one embodiment, the microcontroller 82 further includes an alarm and warning module 180, configured to detect alarm and warning conditions and generate alarm or warning messages for display at the display, or activation of the indicators. For example, the microcontroller 82 may generate an alert or notification message if a user of the terminal 14 fails to timely indicate administration of medication. A user of the terminal 14 may timely indicate administration of medication by, for example, reading the DOTs associated with the patient and the medication.

The microcontroller 82 may include a scheduling module 182 configured to manage scheduled tasks such as medication administration times, to monitor user input indicating completion of scheduled tasks or rescheduling thereof, and user notification of scheduled tasks. For example, a patient may be scheduled for administration of a particular medication at a predetermined time. The terminal 14, may be configured with a schedule monitoring function at the scheduling module 182 to track an elapsed time after a predetermined medication administration time and may generate an alert or notification message if no indication of medication administration has occurred within a predetermined alert time. As with the server based system, the predetermined alert time may be, for example, 30 minutes or one hour after a scheduled administration time. Thus, the scheduling module 182 may monitor data entry for receipt of scan codes or symbols indicating administration of a medication or completion of a task, for example, which correspond to scheduled medication administrations or tasks. In the event the scheduling module 182 determines that the elapsed time following a scheduled medication administration exceeds some predetermined latency time, and no scan codes or symbols or other data input have been received to indicate completion of the scheduled medication administration, the scheduling module 182 facilitates activation of an indicator or display of an appropriate message at the display 72. The terminal 14 may continue to periodically display or sound the notification or alert until acknowledgement by the user of the terminal 14. The user of the terminal 14 may acknowledge the alert or notification by, for example, selecting a soft button on the touchscreen display of the terminal 14 or by performing the process associated with the alert. The terminal 14 may present the alert on a display, using one or more indicators, audibly, or using some other way or some other combination of ways.

In one embodiment, the terminal 14 is configured to schedule notification for a follow-up task in response to an event such as administration of a medication or treatment. For example, in response to receipt of user input indicating administration of a medication, the scheduling module 182 schedules a follow-up visit notification or reminder for the user to visit the patient and perform an additional task. In one particular example, a nurse may administer a pain medication and input corresponding information into the terminal 14. In response to receipt of information regarding the administration of the pain medication, the scheduling module 182 schedules a notification for a predetermined time following administration of the medication, such as one hour. In addition, the notification may include instructions to perform an additional task or enter additional information, such as patient heart rate or a pain score provided by the patient. Subsequently, the terminal 14 notifies the user, upon lapse of the predetermined time, with instructions to visit the patient and perform a predetermined task or obtain and input predetermined information or data, such as a pain level either pre- or post-administration of an analgesic medication.

### Transmitting Data

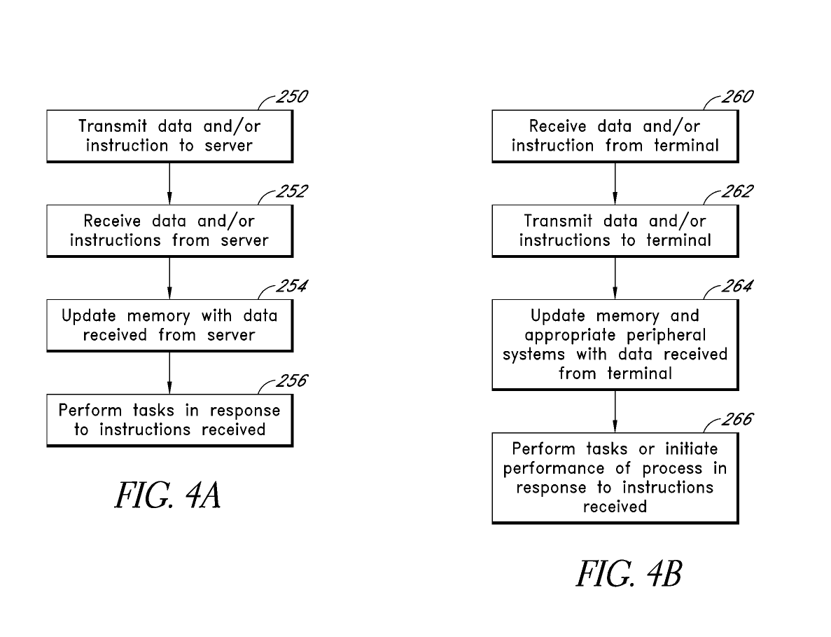

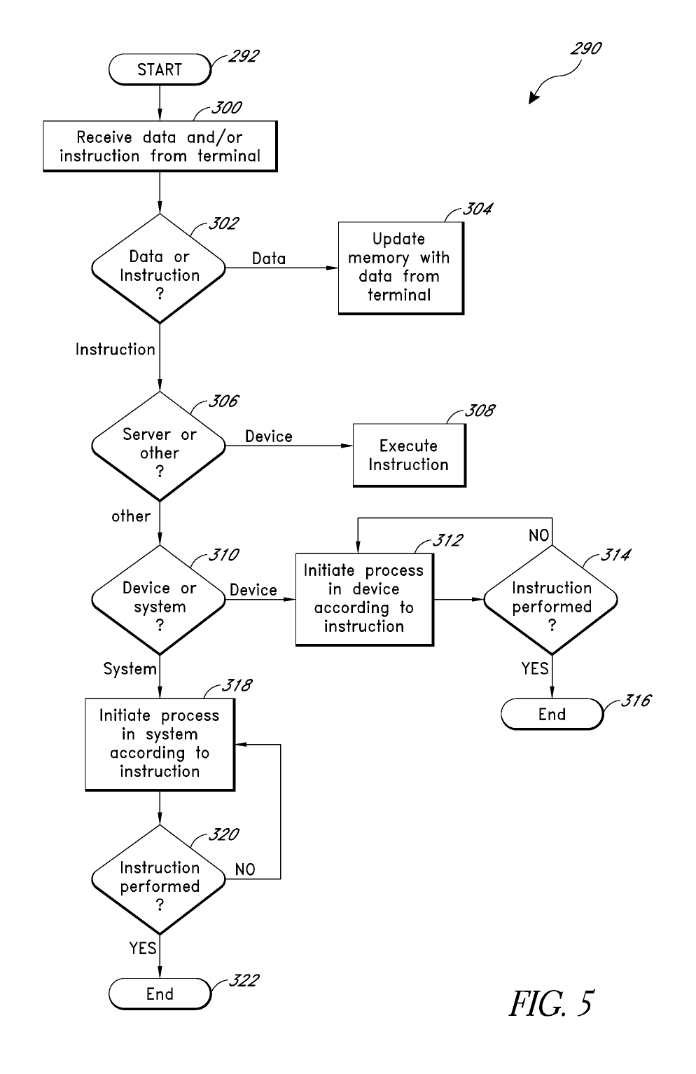

FIG. 4A is a flowchart illustrating one embodiment of a method of operation of a terminal 14 during a communication session. Starting at state 250, the terminal 14 transmits data and/or instructions to the server 12. Next, at state 252, the terminal 14 receives data and/or instructions from the server 12, and then at state 254 the terminal 14 updates its memory with the data received from the server 12. Finally at state 256, the wireless terminal 12 performs the instructions received from the server 12 (for example, displaying a message on the display).

One embodiment of a method of operation of the server 12 during a communication session with a wireless terminal is illustrated by the flowchart of FIG. 4B. Starting at state 260, the server 12 receives data and/or instructions from the terminal 14. Next, at state 262, the server 12 transmits data and/or instructions to the terminal 14. Then at state 264 the server 12 updates memory and the appropriate peripheral systems, such as the patient record system, with the data received. Finally, at state 266 the server 12 performs tasks or initiates performance of a process in response to instructions received from the wireless terminal 14.

In one embodiment the terminal 14 communicates directly with a peripheral device, either via wireless or wireless data link. Generally, after communicating directly with the peripheral device, the terminal 14 will send the pertinent data to the server 12 for storage and retrieval.

### Processing Data and Instructions

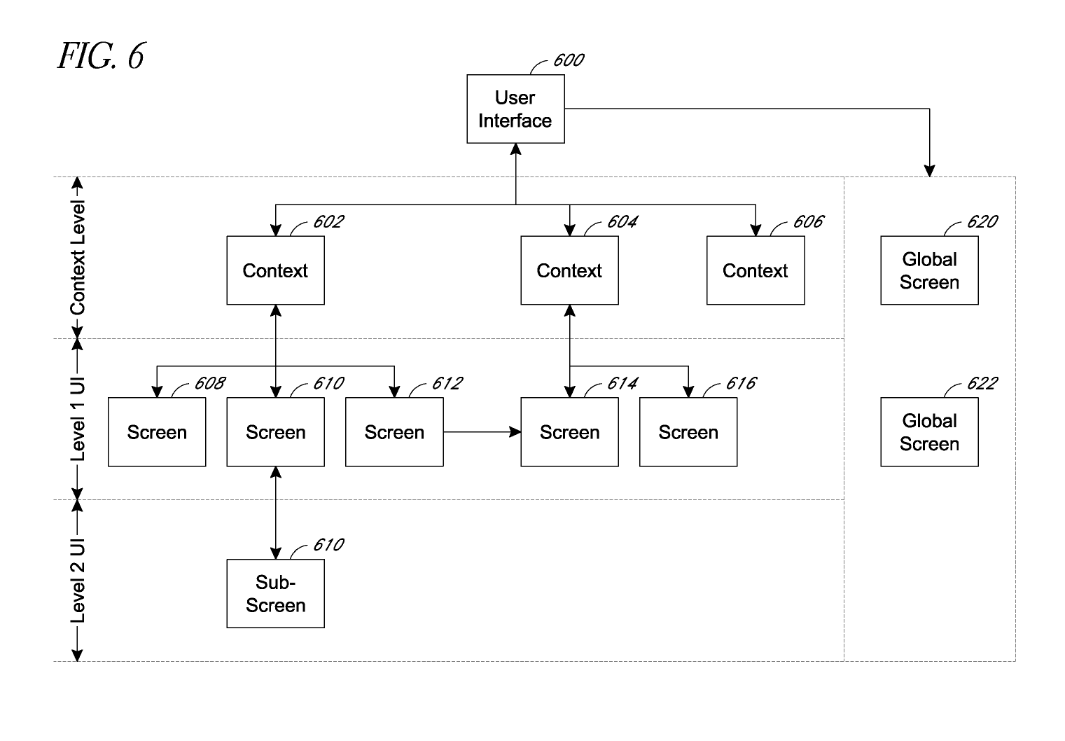

One embodiment of a method 290 of operation of the server 12 in response to receiving a scan code or other data input (for example, from a touchscreen interface) from a terminal 14 is illustrated in more detail in the flowchart of FIG. 5. As illustrated in FIG. 5, the method begins at a start state 292, and proceeds to a state 300 wherein the server 12 receives a data packet including data and/or an instruction from the terminal 14. In a state 302, the server determines whether the received data packet includes data or an instruction. If the received packet includes data, the server 12 proceeds to a state 304 wherein memory is updated with the data. The server 12 may also send the data to the appropriate peripheral system such as the patient record system 30 or the financial system 29 for billing purposes.

If the received packet includes an instruction in state 302, the server proceeds to a state 306 to determine whether the instruction is to be performed by the server 12 or another device or system. If the instruction is to be performed by the server 12, the method proceeds to a state 308 wherein the server 12 executes the instruction. If the instruction is to be performed by a device or system other than the server 12, the server 12 proceeds to a state 310 to determine whether the instruction is to be performed by a peripheral device, such as the printer 20, or a system, such as the messaging system 22.

If the instruction is to be performed by a device at state 310, the server 12 proceeds to a state 312 where the process is initiated in the designated device according to the instruction by either sending the instruction directly to the device, or modifying and formatting the instruction and sending a formatted instruction to the designated device. Following initiation of the process in the designated device, the server 12 may query whether the instruction has been performed or completed in a state 314. If the instruction has not been performed, the server 12 can initiate the process in the designated device again by returning to state 312. If the instruction has been performed, the server 12 proceeds to an end state 316. In addition, the server 12 can send a message to the terminal 14 notifying the user that the process initiated in response to the received instruction has been completed. If the peripheral device designated to perform the instruction is not connected to the server 12, the instruction processing logic or similar logic existing on the server 12 will exist on the terminal 14, the peripheral device or a combination of both. Generally, after completing the instructions, the peripheral device or the terminal 14 will pass the pertinent data to the server 12 for storage and retrieval.

If the server 12 determines at state 310 that the instruction is to be performed by a system, the server 12 initiates the appropriate process in the designated system or sends the instruction to the system designated as part of the instruction. In a state 320, the server 12 queries the system as to whether the instruction has been performed. If the instruction has been performed, the server proceeds to an end state 322, and if the instruction has not been performed the server returns to state 318 and sends the instruction to the designated system again to be performed. Alternately, if the instruction is in the process of being performed, or is waiting to be performed, the server 12 will continue to query the system until the instruction has been performed. In addition, the server 12 can notify the user of the terminal 14 that sent the instruction that the instruction has been performed by sending a message to the terminal 14 for display.

### Wireless Terminal Touchscreen User Interface

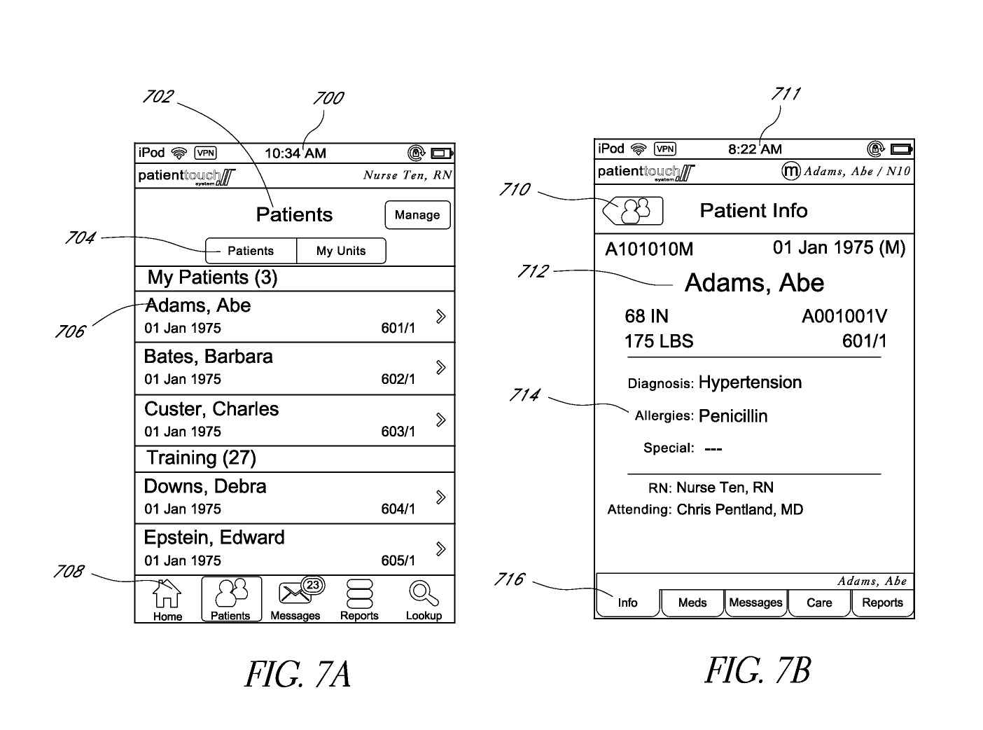

The wireless terminal may implement a user interface that works with various aspects of the wireless terminal such as a touchscreen display, a scanner, a camera, physical buttons, indicators and others. FIG. 6 is an exemplary diagram of a user interface 600 topology. The user interface 600 may be organized around “contexts”, such as contexts, 602, 604 and 606, such that certain user interface elements and certain data are made available or unavailable based on the context. Each context may be defined by a set of functions, screens, tabs, user interface elements, fonts, colors and other aspects such that the context may be easily identifiable by a user of the wireless terminal and may present only relevant information to that user. For example, a context may have all menu bars in a particular color so that a user may quickly recognize the context of the user interface at a particular time. Additionally, each context may have organizational structures such as screens and navigation elements that may be at multiple levels. As shown in FIG. 6, context 602 may include a set of related screens: 608, 610, 612 and 618. Further, these screens may be at different levels of the interface, such as level 1 for screens 608, 610 and 612, and level 2 for sub-screen 618. A first level screen, such as screen 608, may include several interface elements such as tabs or buttons which lead to higher or lower level screens, which themselves may have additional tabs or buttons. In general, the different levels of the user interface may be traversed using user interface elements such as buttons, tabs, links, icons and other elements as are known in the art.

Each context may have varying levels of user interface. For example, while context 602 has three levels of user interface (including the context level), context 604 has only two and context 606 has only one. Each level of the user interface may include interface elements that allow a user to traverse up or down one or more levels. For example, sub-screen 618 may include an interface element that allows a user to traverse back to the level above or the context level 602 directly. Additionally, the user interface 600 may include globally available screens, such as global screens 620 and 622, which are available from any screen within any context.

Access to different contexts and levels within contexts, and in particular screens within contexts, may be dictated by permissions or privilege levels set by the medical management system. The permissions or privilege levels may be dictated by a user type or may be tailored for individual users. For example, nurse in training may be designated by the system as such and be given limited access to contexts, screens within those contexts, data within contexts, etc. As another example, a supervising nurse may have access to all contexts and all screens. Similarly, a nurse in training may have access to screens, but not functions within screens based on permissions set by the medical management system. In this way, a single user interface can be adapted to a wide variety of users while ensuring patient safety.

For example, a user interface may include a “Caregiver Context” in which a subset of user interface elements are available to complete a subset of tasks that access a subset of the medical management system's data. The Caregiver Context may include a “Home” screen that is accessible via, for example, a similarly named button, icon or tab, and that displays a medical management system database name as well as a wireless terminal user's name. The Home screen may also include an interface element such as a button, icon or tab that links to an “About” screen, which displays version information about, for example, the software version, the firmware version, the operating system version, battery status and scanner status, among other things. The Home screen may also include an interface element that links to a “Help” screen that is accessible, for example, via a similarly named button, icon or tab, and that displays information regarding the meaning of iconography and screen and context indicator colors. Finally, the Home screen may also include an interface element that links to a “Logout” screen that is accessible via, for example, a similarly named button, icon or tab and that allows a user to logout of the particular wireless terminal.

The Caregiver Context may also include a “Patients and Units” screen that displays a list of all patients a user has access to, and which may allow a user to select patients for assignment. In some embodiments, the patients may be organized by assignment. In some embodiments the patients may be organized alphabetically. The Patients and Units screen may also include a user interface element that causes a list of the user's units to be displayed. These units may likewise be organized in a variety of fashions.

The Caregiver Context may also include a “Messages” screen that contains all messages sent to a user. Messages may include: text messages; e-mail messages; notifications of person-to-person chat updates; notification of patient care team group chat updates; workflow notifications; notifications regarding tasks assigned to a user that have been added or removed; stat orders; system notifications; and other types of notifications. Selecting a message within the Messages screen may transition the user interface to a message-specific viewing and action screen, which may be a universal screen such as universal screen 620 in FIG. 6. That is, the message-specific viewing and action screen may be available from within any context. The message viewing and action screen may allow a user to toggle, sort or filter between viewing different messages based on aspects of those messages, such as: delivery time, patient the message is related to, priority of the message or others. Each message may further include specific actions that become available when selected. The message-specific viewing and action screen may also allow a user to compose messages, reply to message, delete messages and otherwise interact with the messages.

The Caregiver Context may also include a “Tasks” screen that, for example, contains all tasks for all patients a caregiver is assigned to, including tasks relating to: administration of medication; blood draws; interventions; and others. The Tasks screen may toggle, sort or filter between tasks based on aspects of each task, such as urgency of the task, patient the task is related to, and others. Selecting a task within the task list may move to another screen, such as a task detail screen where details of actions that can be performed related to the task may be displayed. A caregiver viewing a detailed task screen may complete actions such as: reject the task; delaying the task, or reassigning the task. Furthermore, selecting a task may change the context of the user interface from, for example, the Caregiver Context to a “Patient Context.” For example, as shown in FIG. 6, screen 612 may be a task screen within the Caregiver Context that includes tasks related to one or more patients. If a caregiver selects a task to complete, the user interface 600 may move to screen 614, which is within a different context, such as the Patient Context. Also, selecting a task may require a caregiver to, for example, scan his or her badge to document any task that is going to be completed.

The Caregiver Context may also include additional screens such as search screens and others based on the medical management system implementation and the preferences of users.

The user interface may also include a “Patient Context” in which a subset of user interface elements are available to complete a subset of tasks that access a subset of the medical management system data. The Patient Context may include a “Patient Info” screen that displays the names of the caregivers responsible for that particular patient. The Patient Info screen may also link to a screen with patient-specific messages, such as patient text messages, e-mail messages, chat room messages and patient-specific system messages.

The Patient Context may also include a “Patient Tasks” screen that includes all tasks ordered for a particular patient, including, for example: administration of medications; blood draws; care interventions and others. The tasks may be sorted or filtered, for example, based on schedule priority. Example priorities may include: stat, urgent, late, due, upcoming and others as are necessary. Notably, the aforementioned list is exemplary and any number of priorities may be programmed into the medical management system. The task list may use, for example, different texts or colors or styles of texts to display which patients have been assigned to a particular caregiver when viewing all patients. For example, tasks assigned to a caregiver logged into the wireless terminal may be presented in normal text, while tasks that the caregiver can perform but which are not assigned to caregiver may be greyed out. As a further example, tasks assigned to a patient that assigned to a caregiver, but which the caregiver is not allowed to perform may be displayed with italicized grayed text.

Selecting a task on the Patient Tasks screen may lead to a new screen where detailed orders are presented. For example, detailed orders regarding a medicine administration may be displayed after selecting a medication administration task from the Patient Task screen.

The Patient Context may also include a “Medication Orders” screen that displays all current verified orders sent by the pharmacy or computerized provider order entry (CPOE) system interface for the particular patient. The individual medication orders may be sorted or filtered, for example, based on schedule priority. Example priorities may include: stat, confirmed, prepped, late, due, upcoming, PRN and others as are necessary. Notably, the aforementioned list is exemplary and any number of priorities may be programmed into the medical management system. A user may select a medication order and choose to delay or not administer the complete order. In such a case, the wireless terminal may prompt the user for a reason code. Selecting a medication order may result in an orders detail screen being displayed so that a user may review the order details and proceed with the administration. Selecting a medication order may also result in a clinical prompt that is related to the medication, such as: “measure blood sugar before administering insulin.” The order details screen may also display the previous responses to clinical prompts as well. For example, the order details screen may display the patient's last several blood-glucose measurements before previous insulin administrations.

A user may scan administer a drug not currently on the Medication Order screen by scanning a medication using the wireless terminal to indicate administration of a drug not currently ordered for the patient. After scanning the drug, the user may be prompted for a response code that explains why they are administering medication without an existing order in the system. In such a scenario, the user may be stepped through medication check screens to check for patient allergies and interactions with the drug that is going to be administered.

The Medication Order screen may also include a “Med Prep” button that when selected brings the user to a particular workflow to prep medication. The workflow may include screens for: selecting a medication to prepare; review order details regarding that medication; scanning the medication to indicate commencement of medication preparation; indicating dosage of the medication; responding to clinical prompts tied to the medication; and completing the medication preparation.

The Patient Context may also include a “Care” screen that includes all interventions assigned to a particular patient. Interventions assigned to the logged-in caregiver may appear in regular text; interventions not assigned to the logged-in caregiver may be displayed with greyed out text; and interventions that the logged-in caregiver is not privileged to perform may be displayed in italicized, greyed out text. The interventions may be sorted or filtered, for example, based on importance. Example importance levels may include: confirmed, due, scheduled, available and others.

The Patient Context may also include a “Labs” screen that contains lists of tests that are due or that have been completed. In some embodiments, these lists are created through a link to a laboratory system, such as laboratory system 26 of FIG. 1. The list of tests may be sorted or filtered based on priority, such as collected, due and available. Further, the tests may be distinguished by privilege and assignment to the user. For example, tests assigned to the logged-in caregiver may appear in normal text while tests that the caregiver can perform but which are not assigned to the caregiver may be displayed in greyed out text.

The Labs screen may include tabs that lead to other screens and the functionality of the tabs may be based on privileges set by the medical management system. For example, a phlebotomist lab tab may be viewable only by the patient's assigned phlebotomist.

The Labs screen may have a button such as “Begin Collect” that commences a blood draw workflow. In an example workflow, the user may select an order from a select orders screen. The user may then be stepped through prompts where responses are necessary. For example, the user may be promoted to enter the patient's current blood pressure. The user may then be taken to the “Collect and Print Labels” screen, to print appropriate labels for test tubes in which the drawn blood will be stored. The user may then complete the blood draw and scan his or her badge to indicate completion. Specific examples related to collection of a blood draw, collection of a specimen, and infant care are each discussed further below.

The user interface may also include screens that are globally accessible despite being in any particular context. For example, a “Mobile View” or “mView” screen may be globally accessible by clicking on an “m” icon available on each screen in the user interface. The “m” icon may be placed so as to be easily accessible, but so as to take up as little room as possible. The mView may display most recently collected patient information for a specific patient such as, for example: administered medications; recent vitals; assessments; inputs and outputs; procedures; and others. Importantly, mView may display both data collected by wireless terminals and shared with the medical management system, as well as data collected directly from interfaces with other systems, such as the Laboratory System 26 of FIG. 1. The mView screen may be configured to be read-only so as to preserve the accuracy of the patient's medical record.

The user interface may include another globally accessible screen such as “Communication Center” or “Comms Center.” The Comms Center may be made accessible by placing an icon, such as a telephone icon on each screen in the user interface. The Comms center may include tabs such as “Contacts”, which allows a user to: view saved contacts, listed alphabetically; search a directory by name, site, unit, or role; save new contacts to a contacts list; initiate calls or chat messages. The Comms Center may include another tab such as “Messages”, which allows a user to: view all person-to-person chat messages as well as system generated messages and patient chat rooms for all patients the user is assigned to; send additional text chat, voice clip or images from camera; and send additional text chat, voice clip or images from camera. The Comms Center may also include another tab such as “Phone”, which allows a user to call external phone numbers or direct dial an extension.

The aforementioned screens, contexts, tabs and other details are exemplary and may be implemented in different ways based on different medical management systems and users.

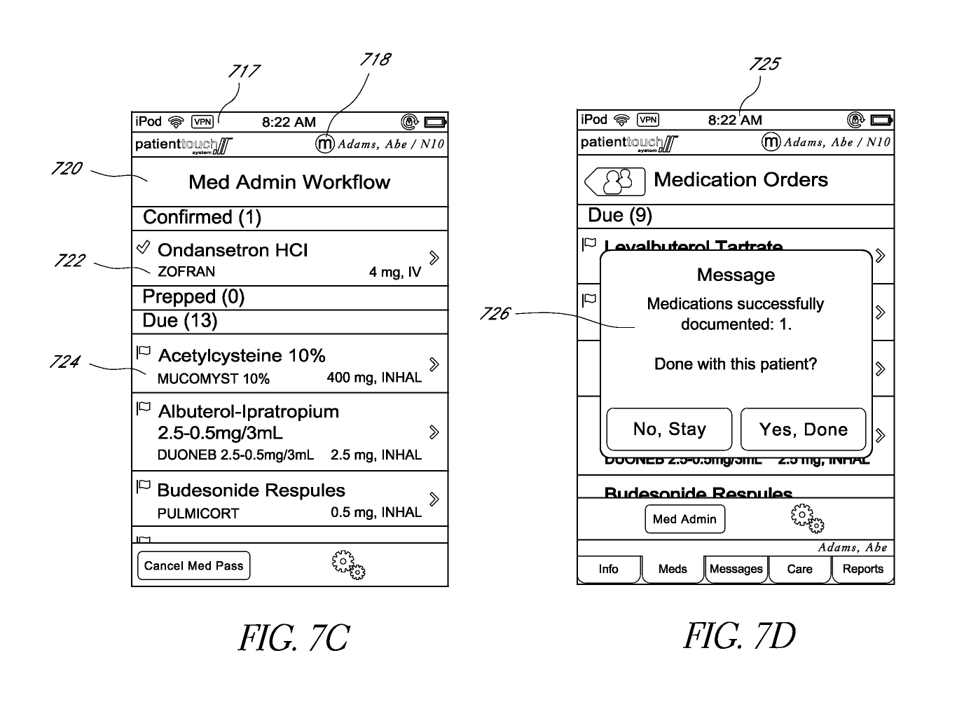

FIGS. 7A-7D are exemplary screens of a user interface on a touchscreen wireless terminal configured to participate in a medical management system. Starting with FIG. 7A, many features of a user interface 700 are shown. A banner 702 indicates that the user interface is in a particular screen within the user interface topology, which in this case is the “Patients and Units” screen, as was described above. Note that the banner 702 may be colored to indicate contexts, such as a Caregiver Context or Patient Context. In this case, the “color” of the banner indicates that the user is in the Caregiver Context. A “color” in this context may refer only to a particular mode of operation, simply by way of illustration. Thus, the term “color” as used herein need not require a banner 702 or any other portion of a screen to have a particular indicated color while in the particular color “mode”. For example, when a handheld is in a “green” mode, the screen of a user interface need not have a green screen. However, in some embodiments, a “green” mode will be indicated to a caregiver by a green banner 702 or the color green illustrated on a portion of or all of the screen.

A button 704 allows different views to be displayed within the Patients and Units screen. The button 704 is a user interface element that allows a user to view different information.

A patient entry 706 displays patient data such as the patient's name, birthdate and other information as necessary. Note the patient data 706 is organized under a heading “My Patients”, which may refer to patients assigned to the particular user logged-in to this wireless terminal.

An icon 708 is another type of user interface element that allows a user to switch between different screens. For example, as can be seen across the bottom of FIG. 7A, several icons including “Home”, “Patients”, “Messages”, “Records” and “Lookup” are available so that a user can navigate to different screens for different information.

Referring now to FIG. 7B, another screen 711 is shown with patient information displayed. FIG. 7B may be displayed after touching the entry 706 of FIG. 7A. Notably, in FIG. 7B, patient specific information is displayed such as the patient's name 712 and patient allergies 714. At the top of the screen a button 710, which is another type of user interface element, is displayed. By touching that button on the touchscreen interface, the user may traverse back to different level of the user interface, such as that shown in FIG. 7A. A tab 716 is another example of a user interface element that allows a user to move to different screens with different information. As illustrated in FIG. 7B, several tabs may be available including “Info”, “Meds”, “Messages”, “Care” and “Reports”. As described above, each of these tabs relates to specific information about the patient that has been selected.

Referring now to FIG. 7C, another screen 717 is shown with displayed medicine administration workflow information. A banner 720 may be a different color when compared to that illustrated in FIGS. 7A and 7B. A change in color or the banner 720 indicates the context has changed from a Caregiver Context to a Patient Context. As described above, in the Patient Context, many options may be removed from the screen so that a user, such as a caregiver, can focus on the correct administration of medicine to the patient and not be distracted by any other function of the system, such as the messaging function. FIG. 7C shows a plurality of medications that have been ordered for a particular patient, whose name appears at top right. Note that the medication treatments are organized in this case by the “Confirmed”, “Prepped” and “Due” banners. Additional banners may not be visible depending on the number of orders and so the screen may be scrolled to reveal other orders. The checkmark icon next to the drug indicated at 722 may indicate that medicine has been administered successfully to the patient. Other icons, such as the flag indicated at 724 may indicate the administration of that medicine is due, past due, urgent or the like. Notably, the medication orders illustrated in the list in FIG. 7C include a variety of information, such as the medicine's chemical name, trade name, dosage and administration method (for example, an IV). If a user were to touch one of the medicine order entries, the user would be taken to a details page (not shown) regarding that medication order, as described above.

As noted above, a change in color on the display may indicate a change in context or mode of operation for the handheld device. A change in color may also indicate whether a particular caregiver task must be completed before any further message, order, alert or notification may be received or before any new task may be started. Certain colors or “modes” may indicate whether a caregiver is participating in a clinically risky activity. For example, a “blue” color may indicate a mode in which a caregiver is browsing medical information, patient information, or other tasks, but it not committed to a particular medical treatment or medical administration. A “green” color may indicate a different mode in which a caregiver has committed to a medical treatment or medical administration for a patient. While in the green color, the caregiver must complete the medical treatment or the medical administration for the patient and completely document the medical treatment or the medical administration for the patient before the caregiver may receive any message, order, alert, or notification or before the caregiver may begin any new task using the handheld device.

Although a handheld device may indicate a particular context or mode to the caregiver using it, other devices in a medical or hospital network may not be able to view the context or mode. For example, when the handheld device described above is in a green mode, other devices in the network would recognize the handheld as being “busy” without necessarily recognizing the green mode. In other words, when devices within the medical or hospital network attempt to send a message to the handheld device in green mode, the handheld device would not receive the message until completing the task and moving to a new mode and rest of the network would view the handheld as busy.

Still referring to FIG. 7C, an “mView” icon 718 is shown at the top of the screen. This icon may be touched to access the patient's medical view, which may include the patient's electronic health record (EHR).

Now referring to FIG. 7D, an example of a user interface screen 725 is displayed. Prompt 726 is shown overlaying the screen 725 below. The prompt 726 includes buttons that relate to different patient treatment options. In this case, prompt 726 is indicating a medication administration has been successfully documented by the medical management system (for example, it may have been stored in the database 32 of FIG. 1). The prompt 726 also prompts the user to either continue to another treatment or finish treating the patient. If, for example, the user selected the “Yes, Done” button, then the wireless terminal may further prompt the user to scan his or her badge to end the treatment of that particular patient.

### Method of Displaying Patient Data in a Medical Workflow Environment

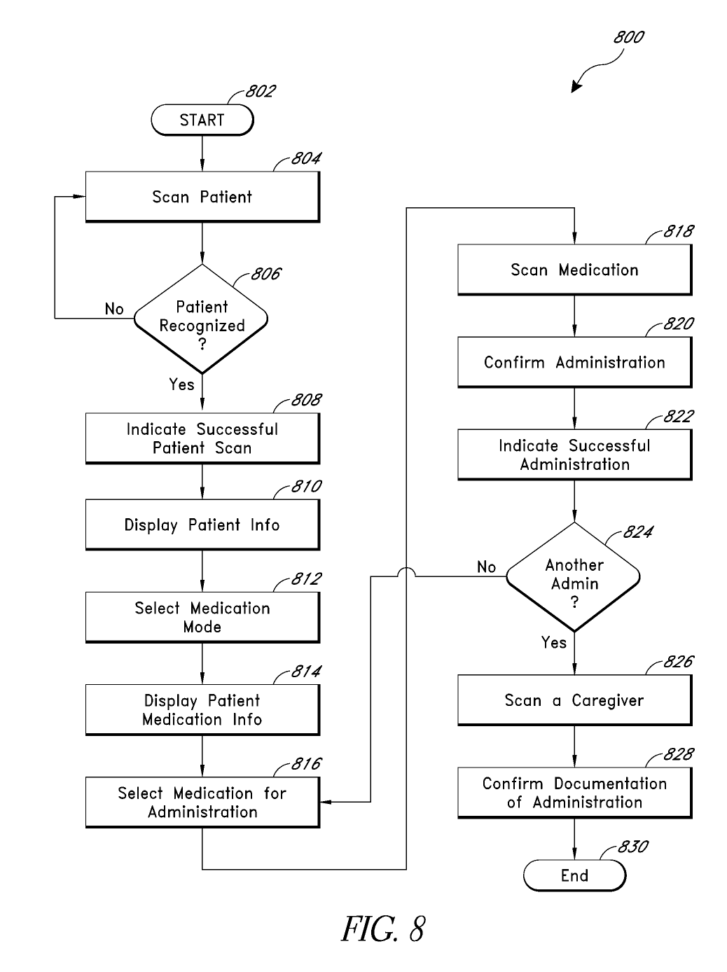

FIG. 8 illustrates a block diagram of one embodiment of a method 800 of displaying patient data in a medical workflow environment. The workflow may be referred to as a treatment transaction wherein the transaction has one or more steps. In some embodiments, method 800 may be performed by the microcontroller 82 of FIG. 3. In some embodiments, method 800 may be performed by a terminal 14 illustrated in FIG. 1. The method starts at a state 802 and moves to state 804 where a caregiver scans a patient using a wireless terminal, such as that described above. In one embodiment, a wireless terminal performing method 800 includes a scanner configured to scan identification codes or symbols, a processor, and a data storage device connected to the processor. A medical management system may identify the patient using a barcode or other machine-readable symbology attached to the patient. For example, the wireless terminal may be used to scan a wristband on the patient. The wristband may contain a bar code or other symbology or an RFID device corresponding to a unique patient identifier. In an alternative embodiment, the patient may be identified by the system via a biological identification device, for example, a fingerprint reader or a retinal reader.

The method then moves to state 806 where it is determined whether or not the patient is recognized by a medical management system, such as that described with reference to FIG. 1. To do so, in some embodiments, the wireless terminal performing method 800 may translate the scan data into, for example, a unique patient identifier and transfer it to the medical management system's server. The server may then check the patient identification data against its database records. Alternatively, the wireless terminal may have a local database of patient data that the unique identifier may be checked against. In some embodiments, the wireless terminal may locally store (for example, within the wireless terminal's memory) identification numbers for the patients that the particular caregiver is authorized to treat.

If the patient is not recognized at state 806, then the method returns to state 804 where the caregiver can re-scan the patient. If, however, at state 806 the patient is recognized, then the method moves to state 808 where an indication of a successful patient scan is displayed to the caregiver.

At state 808 the wireless device performing process 800 indicates to the caregiver that the patient is recognized by the medical management system. For example, in some embodiments, the name of a patient on a display screen of the wireless terminal may change from one color to another (for example, from red to green) to indicate the patient has been recognized by the system. Other methods of indicating a successful patient scan are also possible, such as: a pop-up window confirming the scan, a sound confirming the scan, a particular graphic being drawn next to the patient's name (for example, a check mark) and others.

The method then moves to state 810 where patient-specific data is displayed on the wireless terminal. The patient data may include, for example, the name, height, weight, sex, allergies, age, address, current medicine history, patient diagnosis, patient medical history, hospital employee identification, attending doctor identification, hospital identification, or other data related to the patient. In one embodiment, the patient data is displayed on an “Info” tab of the wireless device's graphical user interface. The patient data may be used by the caregiver to confirm the correct patient is being treated and to determine the patient's basic condition among other things. By confirming the patient's identity and diagnosis, the patient's rights to be the right patient to receive the treatment for the right reasons are better protected. After the patient information is displayed on the wireless terminal, the method moves to state 812.

At state 812 a medication mode is selected. In one embodiment, the medication mode may be selected by the caregiver selecting a tab, such as a “Meds” tab on the graphical user interface of the wireless terminal. The medication mode may be selected in response to a need to administer a medication to the patient. After the medication mode is selected at state 812 the method moves to state 814.

At state 814 one or more medication treatments are displayed on the wireless terminal's display as described, for example, with reference to FIG. 7C. In one embodiment, the medication treatments may be displayed and organized by due date and time of the treatment. By displaying the medication treatments temporally, the patient's right to have his or her medicine administered at the right time is better protected. In other embodiments the medication treatments may be organized by other methods such as alphabetically based on medication names. In some embodiments, the method of organizing the treatments may be selected by the caregiver. The list of medication treatments may include summary details about each scheduled treatment, such as, for example, the chemical name of the medication (for example, acetaminophen), the trade name of the medication (for example, Tylenol™), the dosage of the medication ordered (for example, 400 mg) and the method of administration or route for the medication (for example, orally). By providing all of the details of the medication treatment to the caregiver, the patient's rights to have the right dose of a medication administered by the right route are better protected.

At state 816 a caregiver may select a medication for administration from those displayed at state 814. Upon selection, the wireless terminal may display specific information regarding the medication and dosage, such as: drug manufacturing data, drug dosage level, route of administration, time of administration or food ingested before drug administration, etc. Once the caregiver has reviewed the detailed medication information at state 816, the method moves to state 818.

At state 818 the caregiver retrieves the medication to be administered and scans it using the wireless terminal. One purpose of scanning the medication is to confirm that the medication being administered is the correct medicine for the patient. Thus, by confirming the correct medication is being administered to the patient, the patient's right to be treated with the right medication is better protected. Another purpose of scanning the medication is to capture additional data about the drug to be recorded by the medical administration system. For example, drug administration data for each administered drug may include a National Drug Code (NDC), the dosage form, the active ingredients, the strength of the drug, the package size and type of the drug, the major drug class of the drug, an FDA approved application number of the drug, a drug manufacturer, a drug manufacturer lot number or other data unique to the drug manufacturer of the given drug. Further drug administration data might include the drug brand name, a drug formulary or an SIG code. After scanning the medication, the method moves to state 820.

At state 820 the caregiver confirms administration of the medication. Confirming administration may be accomplished by, for example, selecting a button on the user interface. Confirming administration may also include entering additional data about the administration, such as a form, site, dosage, etc. By confirming the details of the medication administration, the patient's right to have the right dose is further protected. After confirming administration of the medication to the patient, the method moves to state 822.

At state 822 the user interface indicates a successful medication administration to the user so that the user knows that the details of the administration have been successfully recorded by the medical management system. The indication may be, for example, by adding an icon next to the medication order such as the checkmark shown at 722 in FIG. 7C. Other methods may be used as well, such as changing the type or color of text, using additional icons, etc. After the user interface indicates a successful medication administration, the method moves to state 824.

At state 824 the caregiver decides whether he is she will administer another medication. If at state 824 the caregiver will administer another medication, the method returns to step 816 for the caregiver to choose the next medication to be administered. If, however, the caregiver has no other medications to administer or chooses for some other reason to not administer any additional medications, then the method moves to state 826.

At state 826 the caregiver scans his or her badge or identification number so that the system knows that the caregiver is done treating the particular patient. The method then moves to state 828.

At state 828 the user interface confirms documentation of the caregiver's administration, including, for example, the caregiver's identification, the time of the administration, the type of administration, and other data as is required by the medical management system. By confirming the documentation of the patient's treatment, the patient's right to have their treatment properly documented is better protected. The confirmation may be in the form of a prompt or message that displays to the user that the administration details have been recorded and may further indicate how many administrations have been recorded where the caregiver has given multiple. For example, a prompt such as the prompt 726 described with respect to FIG. 7D may be used. After the confirmation is displayed, the method moves to state 830 where it ends.

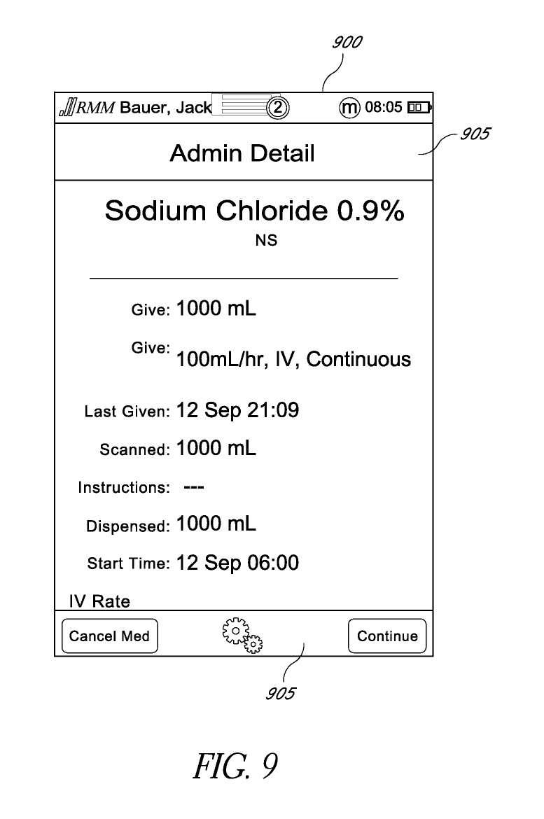

As mentioned above, a change in color on the display may indicate a change in context or mode of operation for the handheld device. Illustrated in FIG. 9 is a screenshot 900 of a handheld device in a “green” mode in which a caregiver has committed to a medical treatment or medical administration for a patient, in this case, “Jack Bauer”. In one implementation, the shaded areas 905 may be green in color. In other implementations, other colors may be used for the shaded areas 905. While in the “green” mode, the caregiver must complete the medical treatment or the medical administration for the patient and completely document the medical treatment or the medical administration for the patient before the caregiver may receive any message, order, alert, or notification or before the caregiver may begin any new task using the handheld device. In this case, the caregiver must complete an intravenous administration of Sodium Chloride 0.9% before moving to a new task. If the caregiver is performing the administration of Sodium Chloride, he or she selects the “continue” button to proceed. If for some reason the caregiver determines not to administer the Sodium Chloride, the “Cancel Med” button may be selected.

Automation of medical workflow may be performed in other contexts in addition to the display of patient data as described above. For example, work flow automation on hand-held wireless devices may be utilized to provide point-of-care blood transfusion safety management. For example, hand-held devices may assist in positive patient identification before blood products are transfused. A Blood Product Administration module implemented on a hand-held device may operate in conjunction with a Laboratory Specimen Collection module to assist blood bank personnel in accurately matching blood samples with correct blood products. This may assist nursing staff in ensuring correct blood products are transfused to the correct patient.

For example, one implementation may include a method of administering blood products. In some embodiments, the method may include assigning one or more units of blood to a patient blood pool from a blood bank. In some embodiments, the method may include checking out an assigned unit of blood from the patient blood pool. In some embodiments, the method may include returning a unit of blood from a patient care area to the patient blood pool. In some embodiments, the method may include releasing blood from the patient blood pool to the blood bank. For more information on an implementation of blood transfusion safety management using a hand-held device, please see the PatientTouch™ System 3.2.2 Blood Product Administration Pilot User Guide, PatientSafe™ Solutions (August 2012), which is hereby incorporated by reference in its entirety.

Another example of medical workflow automation on hand-held wireless devices enables caregivers to collect and label breast milk from mothers admitted to a healthcare facility. Using a unique barcode that matches mother and infant, labeled breast milk can be stored such that it is available as needed for feeding. In situations where a mother is discharged from the healthcare facility while her infant remains admitted to the healthcare facility, pre-printed labels may be utilized when breast milk is collected off the premises of the healthcare facility. The milk may then be brought to the healthcare facility, with the pre-attached labels ensuring the milk is matched with the correct infant. In one implementation, a method of automating the collection and distribution of breast milk may include launching an application on a wireless handheld device and logging in. The login may be accomplished in some implementations by scanning a badge or an identification code of a caregiver. A mother's wristband may then be scanned. The handheld device may then display patient information to allow the caregiver to positively identify the mother. Breast milk bottle labels may then be printed based on additional input from the caregiver. Some implementations may also support printing of labels for home use.

In some embodiments, when labeled breast milk is received, the caregiver may use a handheld wireless device to scan a barcode or other identification code, which may be located on the wrist of (or on a necklace or other article of clothing worn by) a provider of the milk. This may provide for a determination of whether the person is authorized to provide milk for a particular infant. In some implementations, persons authorized to visit the infant may also be authorized to provide breast milk. Individual bottles of breast milk may then be scanned to identify them and record their reception. Additional workflows may be provided to verify breast milk bottles match bins used for storage of the milk.

In some embodiments, the method may include when milk is provided to an infant, an additional workflow may ensure the correct milk is provided to the correct infant but scanning both an infant wristband (or ankle band or other infant identification) and the milk bottle to ensure a match. For more information on an implementation of a breast milk collection and matching workflow on a handheld wireless device, please see the PatientTouch™ System 3.2.2 Infant Care LCR User Guide, PatientSafe™ Solutions (August 2012), which is hereby incorporated by reference in its entirety.

Another example of medical workflow automation on handheld wireless devices allows technicians and caregivers to use a handheld device at the bedside to ensure accurate patient identification, documentation, and specimen labeling. Automation of laboratory sample collection may include management of outstanding lab orders that require collection of a sample. Appropriate caregivers may be selected and notified of specimen collection tasks.

A specimen collection workflow may assist the caregiver with the specimen collection. For example, a specimen collection workflow may include allowing a caregiver to select one or more uncollected specimen orders for a patient. In some embodiments, details of the specimen order may be reviewable by the caregiver before the caregiver proceeds with the collection. The workflow may allow the caregiver to record that the specimen has been collected, and/or print labels for labeling the collected specimens. Task completion information related to the specimen collection may then be displayed for review by the caregiver. After confirming details of a completed specimen collection, for example, by input into the hand-held device, the caregiver may be given the option to complete additional specimen collections. These additional specimen collections may be from the same patient or from a different patient.

Workflows that assist with receipt of the specimens in a laboratory may also be provided. These workflows may allow a lab technician or other healthcare worker to accept or reject specimens. Rejection of a specimen may include marking the specimen for recollection. Some solutions may also provide reporting capabilities to facilitate management of the specimen collection process. For more information on one implementation of specimen collection workflow automation, please see the Patient Touch™ System 3.2.2 Laboratory Specimen Collection LCR User Guide, PatientSafe™ Solutions (August 2012), which is hereby incorporated by reference in its entirety.

While the present invention has been described in connection with certain exemplary embodiments, it will be appreciated by those skilled in the art that various modifications and changes may be made without departing from the scope of the present disclosure. The drawings and the detailed description of certain inventive embodiments given so far are only illustrative, and they are only used to describe certain inventive embodiments, but should not be considered to limit the meaning or restrict the range of the present invention described in the claims. Indeed, it will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. Therefore, it will be appreciated to those skilled in the art that various modifications may be made and other equivalent embodiments are available. Accordingly, the actual scope of the present invention must be determined by the spirit of the appended claims, and equivalents thereof.

What is claimed is:

1. A method of displaying patient data in a medical workflow environment, comprising:
receiving a patient identifier into a hand-held device configured to read scan codes and configured to receive input via a touchscreen display;
displaying patient data on the touchscreen display of the hand-held device;
receiving a medication selection for administration to the patient from a list of one or more medications displayed on the touchscreen display;
receiving a medication identifier into the hand-held device; and
receiving a confirmation of administration of the medication on the hand-held device.

2. The method of claim 1 further comprising scanning a caregiver identifier with the hand-held device.

3. The method of claim 1, wherein the receiving the medication selection for administration to the patient comprises selecting a medication mode from the touchscreen display of the hand-held device, and wherein the display screen is configured to receive input from a user contacting an interface element on the display screen.

4. The method of claim 1 further comprising displaying a plurality of details regarding the selected medication on the touchscreen display of the hand-held device after selecting a medication for administration.

5. The method of claim 1 further comprising displaying an indication of a successful administration of the selected medication on the touchscreen display of the hand-held device after the confirming administration of the medication.

6. The method of claim 1 further comprising displaying an indication of a successful documentation of the administration of the selected medication by a server on the touchscreen display of the hand-held device.

7. The method of claim 1, wherein the receiving a patient identifier into the hand-held device includes receiving a scanned code including at least one of a one dimensional code, a two dimensional code and a radio frequency identification tag.

8. The method of claim 1, wherein the receiving a medication identifier into the hand-held device includes receiving a scanned code including at least one of a one dimensional code, a two dimensional code and a radio frequency identification tag.

9. The method of claim 1, wherein the displaying patient data on the touchscreen display of the hand-held device includes displaying a link to access additional patient data, medication data, medication administration data, hospital procedures, doctor orders, or medical workflow information.

10. The method of claim 1, wherein the receiving the medication selection for administration to the patient from a list of one or more medications displayed on the touchscreen display does not disrupt a treatment transaction.

11. The method of claim 10, wherein the treatment transaction includes a timer to indicate a window for completion of the treatment.

12. The method of claim 1, wherein the receiving a patient identifier, the receiving a medication selection for administration to the patient, and the receiving the medication identifier into the hand-held device comprises a treatment transaction.

13. The method of claim 12, wherein the treatment transaction may not be interrupted until the confirmation of administration has been received on the hand-held device.

14. A hand-held apparatus for use in a medical workflow environment, comprising:
a processor;
a memory electrically connected to the processor;
a scanner electrically connected to the processor and configured to read scan codes;
a touchscreen display electrically connected to the processor and configured to display user interface elements;
a first module comprising instructions for displaying patient data;
a second module comprising instructions for receiving a selection of a medication for administration to the patient from a list of one or more medications displayed on the touchscreen display; and
a third module comprising instructions for displaying confirmation of an administration of the medication for administration on the touchscreen display.

15. A system for displaying patient data in a medical workflow environment, comprising:
a hand-held device configured to read scan codes and read a patient identifier, the hand-held device comprising a processor, a memory, and a touchscreen display; and
a server in wireless communication with the hand-held device, the server configured to receive the patient identifier from the hand-held device, to transmit patient data for display on the touchscreen display, and to receive a medication identifier from the hand-held device.

16. The system of claim 15, wherein the hand-held device is further configured to display patient data on the touchscreen display.

17. The system of claim 15, wherein the hand-held device is further configured to receive a selection of a medication for administration to a patient from a list of one or more medications displayed on the touchscreen display.

18. The system of claim 17, wherein the hand-held device is further configured to display a plurality of details regarding the selected medication on the display screen of the hand-held device after selecting a medication for administration.

19. The system of claim 15, wherein the hand-held device is further configured to display a confirmation of administration of the medication on the touchscreen display.

20. The system of claim 15, wherein the hand-held device is further configured to scan a caregiver identifier.

21. The system of claim 15, wherein the hand-held device is further configured to display an indication of a successful scan of a patient identifier on the touchscreen display.

22. The system of claim 15, wherein the hand-held device is further configured to display an indication of a successful documentation of the administration of the selected medication by a server on the touchscreen display.
